(19) United States
(12) Patent Application Publication
(10) Pub. No.: US 2010/0262333 A1
(43) Pub. Date: Oct. 14, 2010

(54) SYSTEM FOR REGISTRATION AND CONTROL OF THE FUEL CONSUMPTION OF A VEHICLE

(75) Inventor: Orla Aaby Storgaard, Bognor (GB)

Correspondence Address: ROBERTS MLOTKOWSKI SAFRAN & COLE, P.C.;Intellectual Property Department, P.O. Box 10064, MCLEAN, VA, 22102-8064, US

(73) Assignee: INWEMA SOLUTIONS LIMITED, Limassol (CY)

(21) Appl. No.: 12/601,435

(22) PCT Filed: May 22, 2008
(86) PCT No.: PCT/DK08/00191

§ 371 Date: May 5, 2010

(30) Foreign Application Priority Data
May 23, 2007 (DK) PA 2007 00759

(51) Int. Cl. G07C 5/08; H04M 3/42; H04M 1/66; H04W 4/00

(52) U.S. Cl. 701/33; 455/414.1; 455/411; 455/466

(57) ABSTRACT

A system for registration and control of the vehicle fuel consumption, where registration of a first data set that at least includes the volume or weight of fuel consumption and a vehicle identification data are stored in a server which is connected to a communication device for receiving at least a number of first data sets, calculates fuel consumption of each vehicle, the calculation result being compared with a reference data set stored in the served. The server communicates with the owner of a vehicle if the fuel consumption deviates from the stored data set in the server. Fuel consumption data of one or more vehicles is registered automatically whereby the fuel consumption is calculated and several different statistics about fuel consumption obtained from a database. The statistic information for each driver indicates how his/her fuel consumption compares with similar vehicles operating in the same area.

### BACKGROUND OF THE INVENTION

1. Field of Invention

The present invention relates to a system for registration and control of the fuel consumption of a vehicle, where a registration of at least a first data set, which data set at least comprises the volume or weight of fuel consumption and a vehicle identification data are stored in storage means.

2. Description of Related Art

The registration of liquid fuel consumption of a vehicle has previously been performed by noting the relevant parameters in a notebook to determine the fuel efficiency.

This solution may be adequate when the number of drivers and vehicles to be controlled and registered is small. The problem arises when the number of drivers and vehicles increases and the data information becomes more complex.

U.S. Pat. No. 6,510,416 concerns a fuel delivery system performing a refueling operation in accordance with voice command signals audibly provided by a customer situated within a vehicle positioned for refueling. The customer generates audio signals representative of refueling transaction information, such as a request to initiate fuel dispensing activity, data indicative of the fuel type, fuel volume, purchase amount, and form of payment, and a request to terminate the refueling transaction. A microphone detects the customer voice signals and provides audio detection signals representative thereof. A speech recognition device converts the audio detection signals into corresponding fuel dispensing command signals. A controller generates fuel dispensing control signals in accordance with the fuel dispensing command signals and couples these control signals to the fuel dispenser assembly to effect operative control thereof. A speaker unit permits bidirectional audio communications between the customer and an operator messaging facility, which can optionally provide real-time operator voice communications or pre-recorded voice messaging instructions.

U.S. Patent Application Publication 2003/0212479 concerns a method for transmitting data to an electronic component of a motor vehicle, in particular, a navigation system is disclosed. According to the method, data is generated in a computer system that is external to the motor vehicle and is subsequently transmitted by said computer system to a short message service center, for example via the Internet. The data is then polled by the service center in a time-delayed manner and is transmitted via a mobile radio connection as an individual short message in short message service format to the navigation system of the motor vehicle.

European Patent Application EP 1 176 571 A1 describes a system for sharing a fleet of vehicles among a plurality of users where, in preferred embodiments, the shared vehicles are electrically powered, the system comprising a system control computer that assigns vehicles in response to requests by users, and monitors system performance, a computer subsystem through which users request vehicles for trips, and a vehicle subsystem within each vehicle that is in communication with the system control computer allowing the system control computer to monitor the location and status of each vehicle in the vehicle sharing fleet.

### SUMMARY OF THE INVENTION

The object of the present invention is to create a system for controlling the liquid fuel consumption of a vehicle. A further object of the invention is to reduce fuel consumption of vehicles by storing and comparing data and making differences in fuel consumption visible.

These objects can be fulfilled by a system for registration and control of the fuel consumption of a vehicle, where registration of at least a first data set, which data set, comprises at least the volume or weight of fuel consumption and a vehicle identification data, are stored in storage means if modified such that the first data set is stored in a server, which server stores and controls the fuel consumptions of a number of vehicles, is connected to communication means for receiving at least a number of first data sets, and performs calculation of fuel consumption of each vehicle, the calculation result being compared with a reference data set stored in the server, and the server communicating with the owner of the vehicle if the fuel consumption deviates from the data set stored in the server.

Herby, it can be achieved that data about the fuel consumption of one or more vehicles is registered automatically whereby the fuel consumption is calculated and several different statistics about fuel consumption can be made from a database if that database contains a sufficient amount of data. The statistic information can be compared for each driver of a vehicle to indicate where his/her fuel consumption is compared with vehicles of the same type and model operating in the same area. In this way, it will be visible for many drivers that their fuel consumption is too high due to bad driving behavior. For many drivers, a reduction in fuel consumption of 10-20% is possible if they are open to learning a new way of driving. Opening the eyes of the drivers is difficult in a normal way, but by indicating statistics that they are poor drivers, they might be more open for changing their behavior. This change of driving behavior and thereby a reduction in fuel consumption of about 10% for a large number of vehicles is very important seen from an environmental point of view.

A company may e.g., have a fleet of cars, e.g., 1,000 vehicles, in operation. If refueling is always registered in the same database, a number of bad drivers can be indicated. In addition, a number of very good drivers will appear on the list. For the individual company, the change of driving behavior of the drivers might save up to 10% of the fuel consumed. The company can thus investigate why some drivers have high fuel consumption. In some cases, criminal activities of stealing fuel could be indicated by this fuel consumption monitoring system. By using the fuel consumption monitoring system in combination with e.g., a camera, pictures or films could be activated each time a car with a bad reputation is refueled. In this way, criminal activities of stealing fuel will stop immediately. Thus, companies with a large car fleet would experience a substantial saving in costs. In teaching drivers to drive more efficiently and think about fuel consumption when driving, they could save an enormous amount of money and simultaneously reduce the adverse effect on our climate.

The first set of data information may comprise at least some of the following parameters:
Date and time
Identification number of the vehicle (the registration number of the vehicle)
Identification number of the card
Identification number of the driver
Fuel type
Fuel amount
Distance or time
Price

When the driver of the vehicle has performed a refueling, the data information may be sent as a text message via a telecommunication protocol (short message service—SMS) by a mobile phone. The date and time is registered when the SMS is sent or received, and the identification number (ID) of the vehicle, the card and driver along with the liquid fuel type and amount, mileage or time and the price is written in a SMS.

This data information is easily accessible when the driver has performed the refueling and can be typed in the mobile phone and sent via SMS. Hereby, the driver does not need to perform any further actions regarding the registration process.

The data information may be sent via SMS gateways, which connect mobile SMS services with instant message (IM) services, such as the internet, desktop computers, and telephones through speech synthesis.

The reason for using SMS gateways is the access to larger databases, where the data information may be stored and accessed for later use.

The data information sent by the driver of the vehicle is thus received via SMS and stored in a database. The database can be accessed through a computer and is connected to a website on the internet which can be accessed by a user or administrator of the system by the use of a password and a logon name.

### BRIEF DESCRIPTION OF THE DRAWINGS

FIG. 1 illustrates the data information flow of the system.

FIG. 2 diagrammatically depicts the data structure of a website.

FIG. 3 diagrammatically depicts the data structure of a computer program.

### DETAILED DESCRIPTION OF THE INVENTION

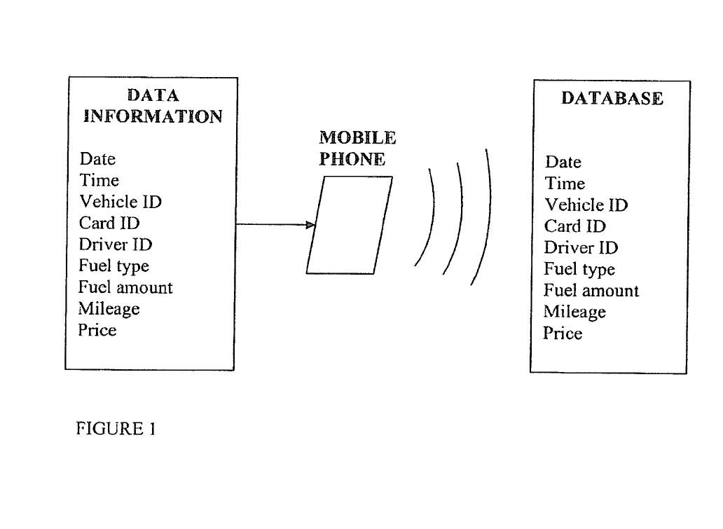

In FIG. 1, the parameters which are to be registered in the database by the driver of the vehicle are listed in the data information box. The first two parameters are the date and time of the registration and these parameters can either be typed in on the mobile phone by the driver of the vehicle or they can be retrieved from the SMS text.

The next parameters are the vehicle ID, the card ID and the driver ID and are likewise typed in on the mobile phone in the same SMS text.

The parameters fuel type and amount, the mileage of the vehicle and the price of the fuel in liters or gallons are observed on the tank display and the display in the vehicle and registered by the driver and equally typed in, resulting in a SMS text that includes all the data information of the performed fueling of the vehicle.

The data information in the SMS text is then retrieved and stored in a database, where the data can be used for further processing such as statistical analysis of the different parameters in the data information.

The database may be connected to a website on the internet, where the database can be accessed by an administrator or a user of the control system by the use of a password and a login name.

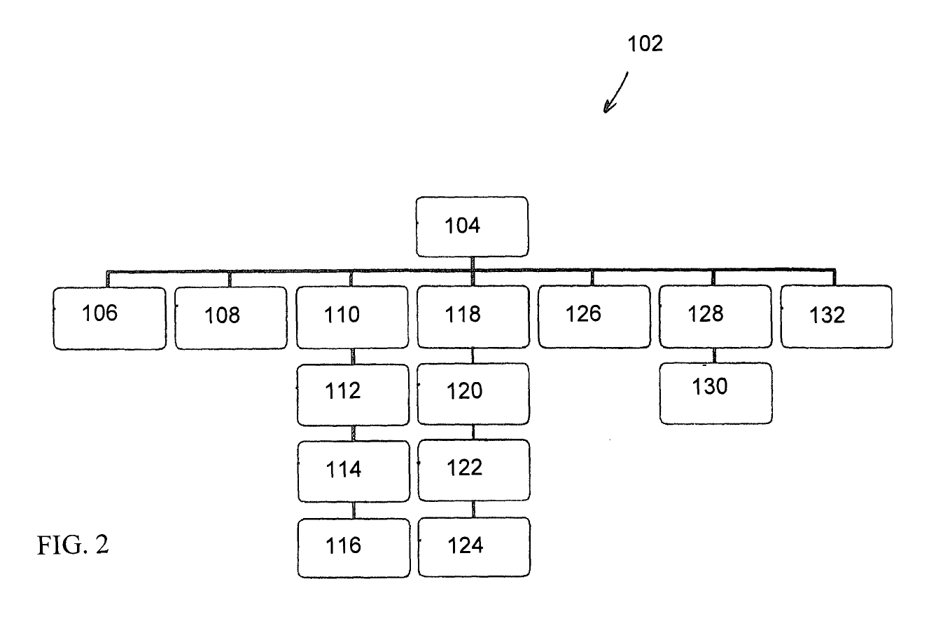

FIG. 2 shows the data structure of a website 102 where 104 is the front (home) page of the website describing the fuel SMS system. Block 106 describes the fuel SMS system and what it is used for.

Block 108 describes how to reduce fuel consumption of vehicles. The block 108 comprises a number of techniques for use by the driver in order to save fuel during normal operation of the vehicle. Block 110 is an information screen for private users comprising an explanation of how a private person may use the fuel SMS system. Block 112 is an activation screen for private users where the new user is activated by a mouse click. Block 114 is a screen indicating “thank you for accepting” and to indicate that a new mail is on its way for the new user for indication that the registration is accepted The block concerns all the information necessary for the user when activating the system via the mail box. By means of block 116, the user activates the system when he has received his/her mail for activation. Here, it is possible for the new user to activate the account each time he logs on to the system.

Block 118 contains general information for larger companies operating a number of vehicles. The block 118 further explains how to use the fuel monitoring system and the prices for using the program.

On block 120, the company can be registered and an administrator can be appointed. Block 122 is an acceptance and “thank you for registering.” This page describes also that the administrator will receive a mail comprising a link to activate the new account.

Block 124 is the actual link which activates the account and the new administrator is able to log on the system.

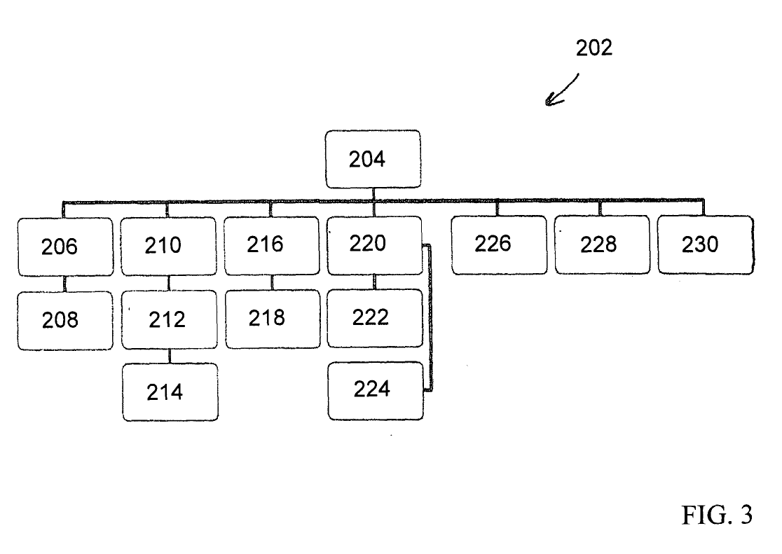

Block 126 concerns contact information and contain contact formulas and further contact information in the form of e-mail or telephone numbers. Block 128 is a logon page for users who are already accepted in the system. Block 130 is the activation of the actual program which program is further described in FIG. 3. Block 132 is a FAQ list including the most asked questions about the fuel monitoring system.

FIG. 3 describes the fuel monitoring program 202 which program at first comprises a welcome screen 204. In the block 206, registration of the fuel consumption is described. This page shows a list of active vehicles for each customer. The customer selects one vehicle from the list or searches the list for a given number. The entire list may comprise the following parameters: registration number, model and average consumption until now.

In block 208, the customer may input new distances and the fuel consumption.

Block 210 is a statistic block which shows a list of active vehicles for a single customer. The customer may select a vehicle from a list or search for a registration number. The list contains the following parameters: the registration number, type of vehicle and average consumption until date.

Block 212 concerns fueling statistics, i.e., a list containing data regarding fuel consumption for the last ten fueling operations. The customer has the possibility to show several fuelings by selecting a date from a row of days. The list contains the following parameters: fueling date, kilometers or miles, the volume that has been fueled and the average consumption since the last fueling.

Block 214 also concerns fueling statistics as described above, but this block depends on a selected date instead of the last ten fueling operations.

Block 216 concerns administration of the user. This section has a list of users connected to the account. The list contains name, mail address, pass word and administrator status.

Block 218 is used for change of user and comprises an input form to register the change of user data. When the data is stored, the customer will return to the user list. Block 220 concerns administration of vehicles and comprises a list of all vehicles connected to the account. Active vehicles which have not been activated by data input are indicated with red. These vehicles can be activated by a mouse click on the screen.

Block 222 concerns activation of vehicles and is used when a new vehicle has to be activated in the system.

Block 224 is an input field for change of vehicle data. When this data is stored, the user will automatically return to the vehicle list.

Block 226 concerns change of company information. This block comprises an input form for change of company data.

Block 228 is a user manual explaining how the fuel monitor system is used.

Block 230 is a type of statistics where a vehicle of a specific type can be selected from a list and the average fuel consumption for all vehicles of that type in the data base is shown.

What is claimed is:

1-7. (canceled)

8. A method for registration and control of fuel consumption of a vehicle, comprising the steps of:
registering at least a first data set comprises set at least the amount of fuel consumed and vehicle identification data,
storing the first data set in a server, which server is connected to a communication means for receiving at least a number of first data sets,
using the sever to calculate fuel consumption of each vehicle,
comparing the calculation result with a reference data set stored in the server, and
having the server communicate with the owner of the vehicle if the fuel consumption calculated deviates from the stored data set in the server.

9. A method for registration and control of the fuel consumption of a vehicle according to claim 8, wherein the first data set comprises:
date and time,
identification number of the vehicle,
identification number of the driver,
fuel type,
fuel amount,
distance or time traveled with the vehicle, and
fuel price.

10. A method according to claim 9, wherein data information is sent as a text message via a telecommunication protocol by a mobile phone.

11. A method according to claim 10, wherein said data information is sent via SMS gateways which connect mobile SMS services with instant message (IM) services.

12. A method according to claim 11, wherein said SMS gateways comprise at least one of the World Wide Web, desktop computers, and telephones via speech synthesis.

13. A method according to claim 11, wherein the data information is sent by the driver of the vehicle and the data is received via SMS and stored in the server, which server comprises a database that is accessed for statistical data information.

14. A method according to claim 13, wherein the database is accessed via a website on the internet.

15. A method according to claim 14, wherein the website is accessed by the use of a password and a logon name.
